(19) United States
(12) Patent Application Publication
(10) Pub. No.: US 2025/0115123 A1
(43) Pub. Date: Apr. 10, 2025

(54) Snowmobile With Descent Speed Control

(71) Applicant: Robert Bosch GmbH, Stuttgart (DE)

(72) Inventors: Naoto Kijima, Northville, MI (US); Kurt Person, Florence, WI (US); Shunsaku Ono, Novi, MI (US)

(21) Appl. No.: 18/905,203

(22) Filed: Oct. 3, 2024

Related U.S. Application Data
(60) Provisional application No. 63/542,845, filed on Oct. 6, 2023.

(51) Int. Cl. B60K 31/12; B62M 27/02

(52) U.S. Cl. CPC B60K 31/12; B62M 27/02

(57) ABSTRACT

A snowmobile having an active descent control for governing downslope velocity and a method of controlling thereof. The snowmobile comprises an active brake controller configured to engage or disengage a brake of the snowmobile independent of a user brake control. The active brake control will engage when the snowmobile exhibits an instant moving velocity greater than a threshold velocity during a descent down an incline. The snowmobile further comprises a number of sensors utilized to determine when it is moving down an incline.

### TECHNICAL FIELD

This disclosure relates to driving controls of snowmobiles.

### BACKGROUND

Snowmobiles operate in cold weather conditions, including surfaces covered in snow and ice. Ice provides a slippery surface that can lead to acceleration of the snowmobile beyond the driver's desired velocity.

What is desired is a system utilizing functions of a snowmobile to control for undesired acceleration during operation, in particular additional control of acceleration caused by motion down a slope.

### SUMMARY

One aspect of this disclosure is directed to a velocity governance method for a snowmobile. The method comprises establishing a target velocity for the snowmobile, generating a descent score indicating whether the snowmobile is descending a slope, engaging a brake mechanism in response to an instant velocity of the snowmobile increasing beyond the target velocity and the descent score indicating that the snowmobile is descending a slope, and disengaging the brake mechanism in response to the instant velocity falling below target velocity. The brake mechanism is suitable to slow the rotation of a propulsion component of the snowmobile during normal operation. The target velocity may be stablished dynamically in response to engagement of one or more driving controls of the snowmobile by a user during operation.

Another aspect of this disclosure is directed to a snowmobile having a number of features. The snowmobile comprises a propulsion component operated using a rotational motion, a throttle control configured to engage the rotational motion, a brake mechanism configured to slow the rotational motion, a brake control configured to engage the brake mechanism, and an active brake controller configured to engage the brake mechanism independently of the brake control. The snowmobile further comprises a memory in data communication with the active brake controller, and a processor in data communication with the active brake controller. The memory stores thereon a target velocity value. The processor is configured to generate a descent score of whether the snowmobile is descending a slope and the active brake controller is configured to engage in response to an instant velocity of the snowmobile increasing beyond the target velocity and the descent score indicates that the snowmobile is descending a slope. The active brake controller may respond to changes in an instant velocity of the snowmobile in relation to the target velocity. In some embodiments, the instant velocity is compared to one or more threshold values to engage or disengage the active brake controller.

A further aspect of this disclosure is directed to an alternative velocity governance method for a snowmobile, the method comprising: establishing a target velocity for the snowmobile, generating a descent score indicating whether the snowmobile is descending a slope, engaging a brake mechanism in response to an instant velocity of the snowmobile increasing beyond a high threshold value and the descent score indicating that the snowmobile is descending a slope, and disengaging the brake mechanism in response to the instant velocity falling below a low threshold value. The brake mechanism is suitable to slow the rotation of a propulsion component of the snowmobile. The high threshold value is at equal to or greater than the target velocity. The low threshold value is equal to or lesser than the target velocity.

The above aspects of this disclosure and other aspects will be explained in greater detail below with reference to the attached drawings.

### BRIEF DESCRIPTION OF THE DRAWINGS

FIG. 1 is a diagrammatic illustration of a snowmobile having components suitable for velocity governance to provide active descent control.

FIG. 2 is a diagrammatic illustration of the snowmobile in two scenarios reflecting real-world operation.

FIG. 3 is a table providing logic values for activation of an active brake controller in a snowmobile according to one embodiment of the invention herein.

FIG. 4 is a series of tables describing a plurality of operating scenarios for a snowmobile having active descent control functions.

FIG. 5 is a flowchart illustrating a method of velocity governance for a snowmobile.

FIG. 6 is a flowchart illustrating a method of velocity governance for a snowmobile providing smoother application of active braking.

FIG. 7 is a flowchart illustrating a method of generating a descent score for use in a velocity governance of a snowmobile.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

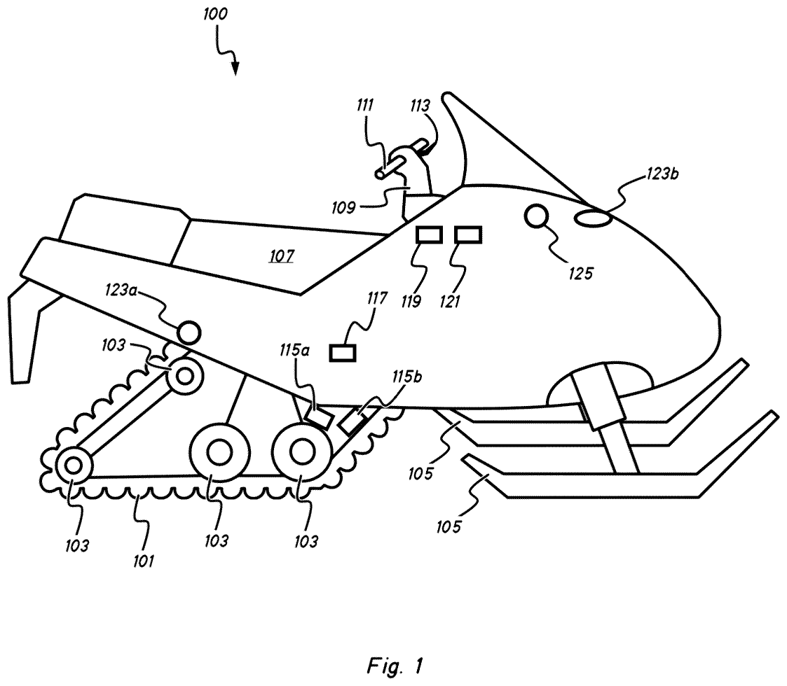

FIG. 1 is a diagrammatic illustration of a snowmobile 100 having features according to one embodiment of the invention disclosed herein. Snowmobile 100 comprises a number of propulsion components, including at least a tread 101 and a number of wheels 103. The propulsion components provide locomotion of snowmobile 100 on surfaces by rotating wheels 103 to move tread 101 against the surface upon which snowmobile 100 rests. In the depicted embodiment, each of wheels 103 may comprise a tread gear suitable to engage with tread 101 to optimally transfer force and create locomotion of the snowmobile 100. Other embodiments may comprise different arrangements without deviating from the teachings disclosed herein.

Tread 101 provides friction with the surface to enable motion in the direction opposite of the rotational direction of the tread 101 and wheels 103. Wheels 103 are subject to rotational motion by a prime mover (not shown), such as a motor. The prime mover may comprise a combustion engine, electric motor, a hybrid combination thereof, or any other prime mover recognized by one of ordinary skill in the art without deviating from the teachings disclosed herein. In the depicted embodiment, snowmobile 100 is depicted with four wheels 103 to drive the motion of tread 101, but other embodiments may comprise additional or a different number of wheels without deviating from the teachings disclosed herein. Forward motion is controlled by a user via a pair of skis 105 that can be angled to turn snowmobile 100 during forward motion. Skis 105 have the capacity to rotate within a range of motion suitable for steering of the snowmobile 100. In the depicted embodiment, skis 105 may provide a range of 90 degrees of rotational motion (i.e., ±45 degrees from a forward or “neutral” position), but other embodiments may comprise different ranges of steering motion without deviating from the teachings disclosed herein. The depicted embodiment comprises a pair of skis 105, but other embodiments may comprise other arrangements without deviating from the teachings disclosed herein.

A user is positioned in a series of controls by resting upon a seat 107. The controls available to the user comprise a steering control 109. In the depicted embodiment, steering control 109 comprises a steering column with a handlebar configuration, but other embodiments may comprise other configurations without deviating from the teachings disclosed herein. In the depicted embodiment, rotation of steering control 109 causes a correlated positional change in skis 105.

Snowmobile 100 additionally comprises a throttle control 111 which is configured to engage the motor to apply rotational motion to wheels 103. Throttle control 111 is utilized by the user to increase the forward-moving speed of snowmobile 100 during operational motion. In the depicted embodiment, throttle control 111 comprises a twist mechanism of a handle of steering control 109, but other embodiments may comprise other configurations without deviating from the teachings disclosed herein. In the depicted embodiment, throttle control 111 exhibits a correlated acceleration function: snowmobile 100 accelerates faster in response to a greater displacement of the twist mechanism. Other embodiments may instead utilize different acceleration function without deviating from the teachings disclosed herein.

Snowmobile 100 additionally comprises a brake control 113 suitable to engage a brake mechanism 115. Brake mechanism 115 increases the drag experienced by the propulsion components of snowmobile 100, slowing the forward operation motion of snowmobile 100. In the depicted embodiment, brake mechanism 115a exerts braking forces upon one or more of wheels 103 and brake mechanism 115b exerts braking forces upon tread 101. Other embodiments may comprise other braking systems with a different number or arrangement of brake mechanisms 115 without deviating from the teachings disclosed herein. In the depicted embodiment, brake control 113 comprises a hand-operated prybar configuration, but other embodiments may comprise other brake control configurations or arrangements without deviating from the teachings disclosed herein. In the depicted embodiment, brake control 113 exhibits a correlated braking function: brake mechanisms 115 exert a greater braking force upon the propulsion components in response to a greater displacement of the prybar. Other embodiments may instead utilize different braking function without deviating from the teachings disclosed herein.

Snowmobile 100 additionally comprises an active brake controller (ABC) 117. ABC 117 is configured to engage brake mechanisms 115 independently of brake control 113. ABC 117 is further configured to engage brake mechanisms 115 only in response to an appropriate data command received from a processor 119 of snowmobile 100. Processor 119 is in data communication (not shown) with ABC 117, as well as a number of other components of snowmobile 100. Processor 119 is in data communication with a memory 121. Stored upon memory 121 is a number of instructions executable by processor 119 during operation of snowmobile 100. Memory 121 may additionally store thereon other data useful for functions of processor 119 or other components of snowmobile 100. In the depicted embodiment, ABC 117 is a distinct element from processor 119 and memory 121, but some embodiments may comprise arrangements of a single microcontroller or sub-processor providing the functionality of two or more of these elements in combination without deviating from the teachings disclosed herein.

Processor 119 is additionally in data communication with a number of sensors. In the depicted embodiment, a number of velocity sensors 123 generate velocity data indicating the moving velocity of snowmobile 100 based upon conditions measured by the respective velocity sensor 123. In the depicted embodiment, velocity sensor 123a generates velocity data by measuring the rotational speed of tread 101. This velocity data may be provided to permit processor 119 calculate the motion of snowmobile 100 in a forward direction. In some embodiments, velocity sensors 123a may instead or additionally measure the rotational motion of one or more of wheels 103 without deviating from the teachings disclosed herein. In such embodiments, the velocity data generated by velocity sensors 123a may be utilized in tandem to generate a normalized value for the instant velocity without deviating from the teachings disclosed herein.

Tread 101 and wheels 103 may be subjected to rotational forces not generated by components of snowmobile 100. Of note are rotational forces exerted on the propulsion components in response to snowmobile 100 traveling along a surface, such as snow, ice, or soil. These external forces can still cause a measurable motion of tread 101 and wheels 103. Thus, a velocity data may still be generated by velocity sensor 123a even if no throttle is applied by a user during operation of snowmobile 100.

Velocity sensor 123b comprises an airspeed sensor that generates velocity data based upon a measurement of airspeed experienced at the chassis of snowmobile 100. An airspeed sensor advantageously is agnostic with respect to the throttle control 111 (and subsequently any rotational forces exerted by the prime mover): the airspeed of air moving past snowmobile 100 during motion does not depend at all upon any use of the throttle or brakes. Velocity sensor 123b may be configured to only respond to moving air in the direction of forward motion for snowmobile 100.

Determining the instant velocity of snowmobile 100 is potentially more complicated than for conventional vehicles utilizing wheels only. Snowmobile 100 is expected to be used in environments with ice and snow surfaces, which are in turn expected to cause slipping and drifting along the surface. For this reason, snowmobile 100 additionally comprises a multi-dimensional accelerometer 125, which is configured to detect changes in motion in multiple directions. Multi-dimensional accelerometer 125 may comprise a 3-dimensional (3D) accelerometer, but other embodiments may comprise a different number of dimensions for measuring acceleration without deviating from the teachings disclosed herein. In the depicted embodiment, a 6-dimensional accelerometer—which measures motion in 3 linear axes, but also in rotations about each of the linear axes—without deviating from the teachings disclosed herein. Other configurations of snowmobile 100 may comprise a different number or arrangement for a multi-dimensional accelerometer without deviating from the teachings disclosed herein.

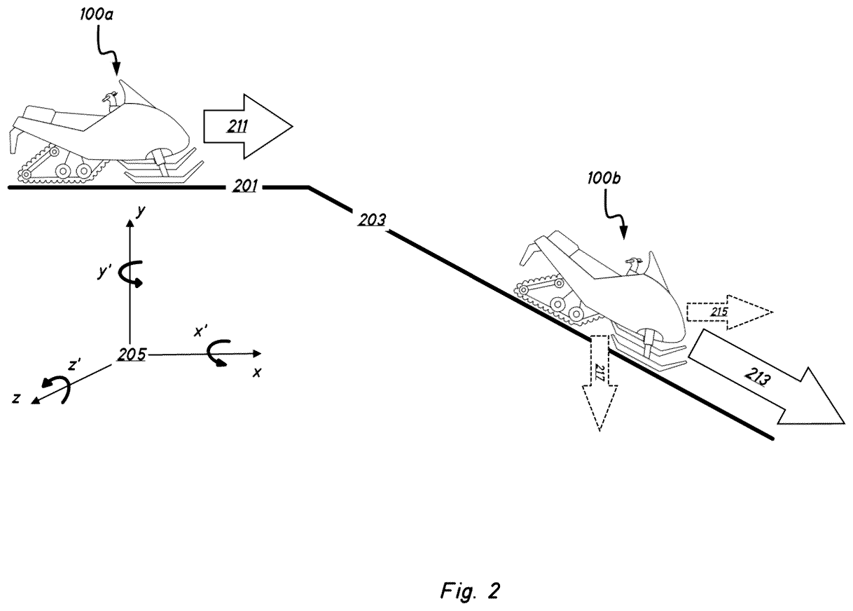

FIG. 2 is a diagrammatic illustration showing a snowmobile 100 in distinct operational scenarios. Each of snowmobiles 100 is identical in this illustration, only distinguished by snowmobile 100a experiencing motion on a level surface 201 and snowmobile 100b experiencing downslope motion on a descent along inclined surface 203.

In the illustration, axes 205 present the 6 axes of motion that are detectable by the multi-dimensional accelerometer 125 (see FIG. 1) of snowmobiles 100. The x-axis measures motion in a first linear direction with respect to a true horizontal (i.e., perpendicular to the pull of gravity). Positive x-axis motion and negative x-axis motion represent movement along the same linear axis, but in opposite directions. The y-axis measures motion in a parallel direction with the pull of gravity: positive y-axis motion corresponds to downward motion in the same direction as the pull of gravity and negative y-axis motion corresponds to upward motion against the pull of gravity. The z-axis measures motion in a direction perpendicular to both the x-axis and y-axis; positive and negative motion along the z-axis are opposite motions. In the depicted embodiment, multi-dimensional accelerometer 125 is additionally capable of detecting motion along additional degrees of movement. The rotational motion along the x′-axis corresponds to the roll of snowmobile 100 during motion along the x-axis. The rotational motion along the y′-axis corresponds to the pitch of snowmobile 100 during motion along the x-axis. The rotational motion along the z′-axis corresponds to the yaw of snowmobile 100 during motion along the x-axis.

The true instant velocity of snowmobile 100 can be extrapolated from measurements of velocity sensors 123 (see FIG. 1) and multi-dimensional accelerometer 125. Finding an accurate reading of the instant velocity of the snowmobile 100 is important to distinguish whether the forward motion is occurring in response to forces controlled by the user (e.g., use of the throttle or inertia from earlier motion initiated via the throttle) or by external forces (e.g., the force of gravity). Advantageously, a snowmobile 100 may activate its active brake controller 117 (“ABC”; see FIG. 1) in response to determining that an undesired amount of external force is responsible for forward motion.

Snowmobile 100a is depicted exhibiting forward motion 211 along flat surface 201. In this scenario, the effects of gravity are nullified by opposite forces exerted by supporting flat surface 201. In this scenario, it can be understood that forward motion 211 is caused only by actions of the user, and thus is desired motion. In this scenario, measurements of instant velocity utilizing velocity sensors 123 are understood to accurate within a tolerance of the user's control.

In contrast, snowmobile 100b is exhibiting forward motion 213 in a downslope direction parallel to inclined surface 203. In this scenario, forward motion 213 comprises two component motion vectors 215 and 217. Component motion vector 215 corresponds to forward motion components occurring in a horizontal direction along the x-axis, and can be understood to be the desired motion of the user. At least some portion of component motion vector 217 corresponds to the force of gravity acting upon the snowmobile 100. Thus, at least some portion of forward motion 213 comprises forces that are exerted beyond the nominal operating controls of the user. In this scenario, additional compensation for this motion caused by undesired forces is advantageous to improve the comfort and safety of the user.

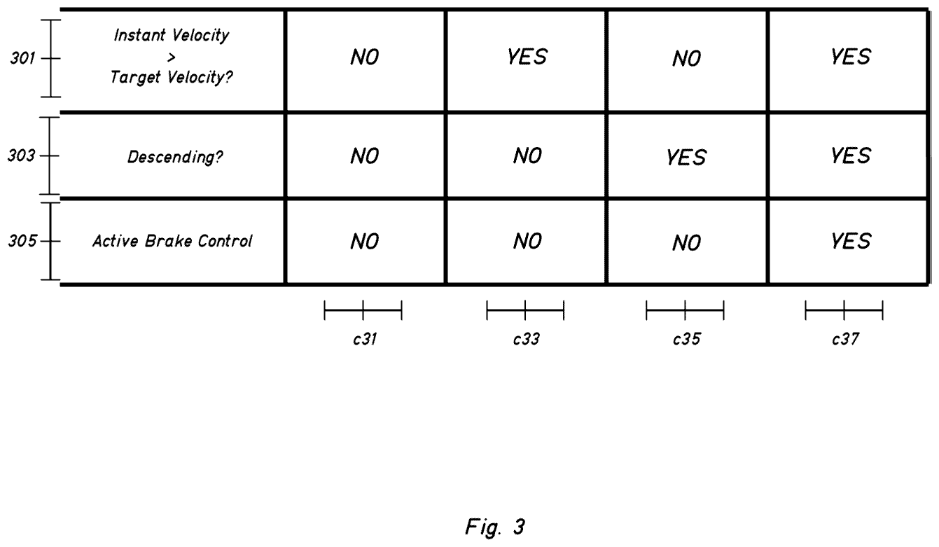

FIG. 3 depicts a chart representing one form of active brake control to provide velocity governance of a snowmobile (such as snowmobile 100; see FIG. 1) according to one embodiment of the teachings disclosed herein. In the depicted example, a target velocity for the snowmobile is selected with respect to forward motion. This target velocity can be utilized as the upper threshold of a “comfort zone” that a user may experience during operation of a snowmobile. Thus, the target velocity may be compared with the instant velocity of the snowmobile to determine whether active brake control is desirable for the user. In order to limit undesired use of the active brake control, it is advantageous to limit utilization of an active brake controller to situations where the user experiences at least some amount of uncontrolled force exerted on the snowmobile.

The Table of FIG. 3 presents a number of scenario c31-c35 in each of its respective columns. Row 301 indicates whether the snowmobile's instant velocity is greater than the target velocity in each scenario. Row 303 indicates whether the snowmobile is experiencing a descent along a slope at the same time. If the snowmobile is experiencing a descent, it is understood that at least some portion of the force exerted upon the snowmobile is not controlled by the user. Row 305 indicates whether an active brake controller is utilized in each scenario, based upon the conditions presented in rows 301 and 303 respectively for each scenario.

Scenario c31 is the first scenario, wherein the snowmobile's instant velocity is not above the target velocity and the snowmobile is not traveling in a downslope motion along an incline. In this scenario, the user is understood to be moving within their range of comfortable speeds, and none of the forces exerted upon the snowmobile are understood to be outside of the user's control. Thus, active brake control is not utilized.

In scenario c33, the snowmobile's instant velocity is greater than the target velocity. However, because the snowmobile is not indicated to be descending, it is understood that the user has controlled this motion, and the instant velocity is desired by the user. Thus, active brake control is again not used.

In scenario c35, the snowmobile is descending, but the instant velocity is below the target velocity. Thus, it is understood that the snowmobile is moving at a velocity within the user's comfortable range of speed, and thus active brake control is not considered necessary.

Finally, in scenario c37, the snowmobile is descending and also the instant velocity is greater than the target velocity. In this scenario, it is understood that the snowmobile is moving at a speed potentially outside the user's comfortable range of speeds and at least some portion of that speed is not provided under the direction of the user. For this reason, active brake control is applied in order to assist the snowmobile in slowing down to the target velocity.

Not all riders will have the same range of speeds of operation in which they feel comfortable while riding. In fact, different users may have different ranges of comfortable speeds in different operating conditions. By way of example, and not limitation, a user may desire a lower target velocity in conditions of low visibility (e.g., during active snowfall) or icier conditions even on the same terrain using the same snowmobile. For this reason, the target velocity may be dynamically adjusted to accommodate for a user's riding behavior and preferences in different riding conditions.

In one embodiment of the teachings herein, the target velocity may be established dynamically by adjusting it according to how the user engages controls of a snowmobile, such as snowmobile 100 (see FIG. 1).

An initial target velocity could be set to the instant velocity of the snowmobile upon activation of a velocity governance function. In some embodiments, this could be established upon initial activation of the snowmobile 100, which would establish the initial target velocity of zero upon initial activation. Other embodiments may comprise a dynamic activation that can be engaged or disengaged at any point during operation of the snowmobile 100.

Whenever a user engages throttle control 111 to accelerate the snowmobile 100 beyond the current target velocity, it can be understood as an indication that user is comfortable at speeds beyond the current target velocity, and in response the target velocity is increased until the speed is reached where the user stops engaging throttle control 111. In some embodiments, the target velocity may be increased at a fixed rate, but in the depicted embodiment, the adjustment of the target velocity is correlated to acceleration applied by the user, as measured by the displacement of throttle control 111. Thus, when the user accelerates rapidly, the throttle control 111 is displaced to a greater extent than if the user chooses to accelerate less rapidly. This corresponding adjustment to the target velocity advantageously minimizes undesired activation of active braking for confident riders.

Conversely, whenever a user engages brake control 113 to decelerate the snowmobile 100 below the current target velocity, it can be understood as an indication that the user is more comfortable with speeds below the current target velocity. In response, the target velocity is decreased along with the instant velocity until the user stops engaging brake control 113. In some embodiments, the target velocity may be decreased at a fixed rate, but in the depicted embodiment, the adjustment of the target velocity is correlated to deceleration applied by the user, as measured by the displacement of brake control 113. Thus, when the user decelerates rapidly, the brake control 113 is displaced to a greater extent than if the user chooses to decelerate less rapidly. This corresponding adjustment to the target velocity advantageously maximizes responsive desired activation of active braking for less confident riders.

Although the depicted embodiment comprises dynamic adjustment of the target velocity in a manner corresponding to the behaviors exhibited by throttle control 111 and brake control 113, some embodiments may exhibit a fixed-rate changes to the target velocity for upward or downward adjustments without deviating from the teachings disclosed herein.

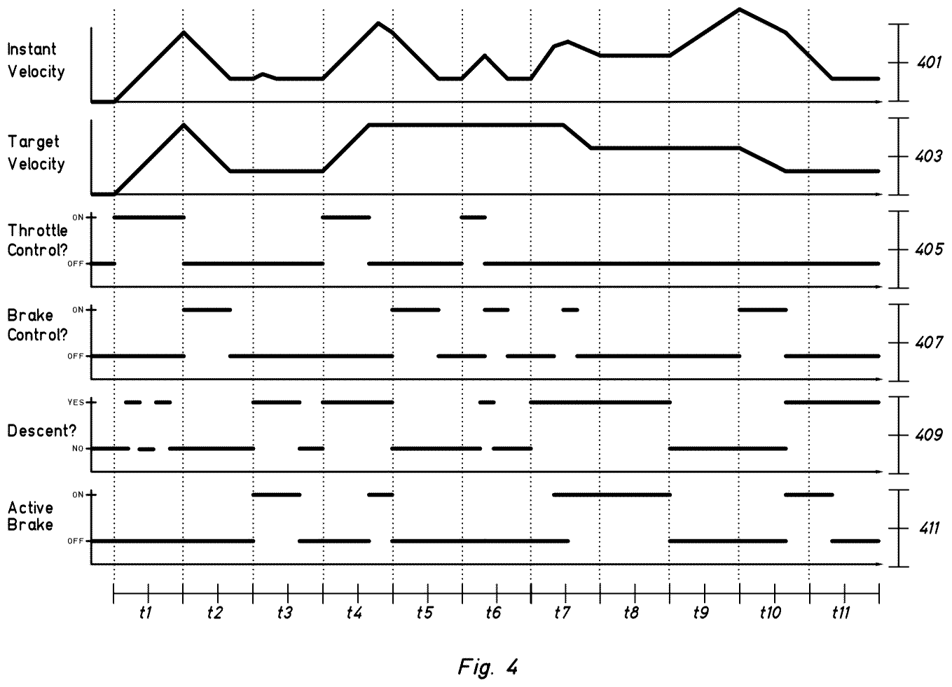

FIG. 4 presents a series of graphs illustrating an example ride of a snowmobile (such as snowmobile 100; see FIG. 1) in different circumstances. Each of the different circumstances are delineated by time segments t1-t11. This example ride is provided only for purposes of illustration, and is not intended to provide limitation to the invention disclosed herein.

Graph 401 indicates the instant velocity of the snowmobile during the ride. Graph 403 indicates the current target velocity of the snowmobile during operation. For the purposes of this illustration, the units of graphs 401 and 403 are miles-per-hour (mph), but any units of speed may be used without deviating from the teachings disclosed herein.

Notably, graph 403 indicates a value of target velocity that is adapted based upon the information provided in the graphs, including its own instant value.

Graph 405 indicates whether the user has engaged the throttle control (such as throttle control 111) at a given point in time. In the depicted example, the extent of throttle displacement is not considered in the adjustments to target velocity for purposes of simplifying the illustrating example. Other embodiments may comprise correlative adjustments without deviating from the teachings disclosed herein. Graph 407 indicates whether the user has engaged the brake control (such as brake control 113) at a given point in time. In the depicted example, the extent of brake control displacement is not considered in the adjustments to target velocity for purposes of simplifying the illustrating example. Other embodiments may comprise correlative adjustments without deviating from the teachings disclosed herein.

Graph 409 indicates whether the snowmobile is experiencing a descent, or downslope motion along a slope or incline. Finally, graph 411 indicates whether the active brake control is engaged in view of the conditions depicted in the other graphs.

Time segment t1 depicts the initial activation and operation of the snowmobile. The throttle control is engaged, and in response the instant velocity increases. The initialized target velocity of 0 mph is surpassed during this acceleration, and the target velocity increases along with the instant velocity.

At the start of time segment t2, the user releases the throttle control, and instead engages the brake control. This correspondingly lowers the instant velocity of the snowmobile, and because the brake control is engaged to slow the snowmobile below the target velocity, the target velocity also decreases in response until the brake control is released. It is noted that during each of time segments t1 and t2 the snowmobile's instant velocity and target velocity are identical, and thus the active brake remains disengaged irrespective of whether the snowmobile is descending.

Starting at time segment t3, the user is engaging neither of the throttle nor the brake control, but the instant velocity begins to increase because the snowmobile encounters a descent and begins downslope motion. Once the instant velocity surpasses the target velocity, the active brake control is engaged to return the instant velocity to the same level as the target velocity. The active brake control remains active until the end of the descent, at which time the snowmobile is permitted to coast.

During time segment t4, the user engages the throttle control, and the snowmobile accelerates. As the instant velocity surpasses the target velocity, the target velocity increases because the user has engaged the throttle beyond the target velocity, indicating confidence with faster speeds. This means the instant velocity never surpasses the dynamically-adjusted target velocity, thus the active brake control is not engaged for most of time segment t4 despite experiencing a descent for the entirety of the time segment. However, near the end of time segment t4, the user disengages the throttle control while the snowmobile is descending. This causes the instant velocity to continue to increase beyond the target velocity on a descent, and thus the active brake control engages until the instant velocity once again is below the target velocity at the end of time segment t4.

During time segment t5, the user engages the brake control when the instant velocity is already below the target velocity. In the depicted embodiment, this means the target velocity remains at its current level because the user activating the brake did not move the instant velocity below the target velocity from the braking action. Other embodiments may exhibit other behaviors without deviating from the teachings disclosed herein. In some such embodiments, the target velocity may be reduced any time that the brake control is engaged, including when the instant velocity is below the target velocity. Because the instant velocity never surpasses the target velocity, the active brake control does not engage at any point within time segment t5.

At the beginning of time segment t6, the user engages both the throttle control and the brake control at different points within the time segment, but because the instant velocity never surpasses the target velocity, the active brake control does not engage at any point within the time segment, irrespective of whether the snowmobile is in descent.

At the start of time segment t7, the snowmobile begins a descent, and the instant velocity increases from the descent until it approaches the current target velocity. Once the instant velocity is greater than the target velocity, the active brake control is engaged. Notably, the user additionally engages the brake control during this activation while the instant velocity is still above the target velocity. Thus, the target velocity decreases during the duration of the user's activation of the brake control. Even though the active brake control is engaged, the target velocity still decreases for the duration of the braking control by the user.

During time segment t8, the descent continues for the entire duration, and the snowmobile experiences acceleration that would normally push the instant velocity past the target velocity. However, once the instant velocity surpasses the target velocity by a small amount, the active brake control engages to maintain a moving speed at the level of the target velocity for the duration of time segment t8.

During time segment t9, the descent has completed, and the user does not engage the throttle control. Nonetheless, the instant velocity increases beyond the target velocity. This scenario can occur when additional sources of forward motion are applied to the snowmobile, such as being towed by another vehicle. In other instances, the user may have disengaged active brake control momentarily at some point between time segments t8 and t9 to create the mismatch between the instant velocity and the target velocity. Irrespective as to why the instant velocity rises above the target velocity, the active brake control does not engage because the snowmobile is not experiencing a descent. This behavior is advantageous in a towing scenario, as it will not engage the active brake in an undesired fashion while the snowmobile is being towed in difficult terrain, such as an uphill slope. Because the user does not engage the throttle control or the brake control during time segment t9, the target velocity does not change during this time segment.

During time segment t10, the user engages the brake control while the instant velocity is greater than the target velocity, and thus the target velocity decreases during the duration of the engagement of the brake control, though the instant velocity never gets as low as the target velocity. Later in the segment, a descent begins. Because the instant velocity is greater than the target velocity during the descent, the active brake control engages for the remaining time of the time segment.

At the start of time segment t11, the active brake control is active, and the instant velocity continues to fall. Later in the time segment, the instant velocity drops to be equal to the target velocity, and the active brake disengages. The ride concludes with the snowmobile coasting at the target velocity.

This set of scenarios is presented for purposes of illustration, and not limitation. The snowmobile may be operated in additional scenarios and additional embodiments of the snowmobile may be utilized without deviating from the teachings disclosed herein.

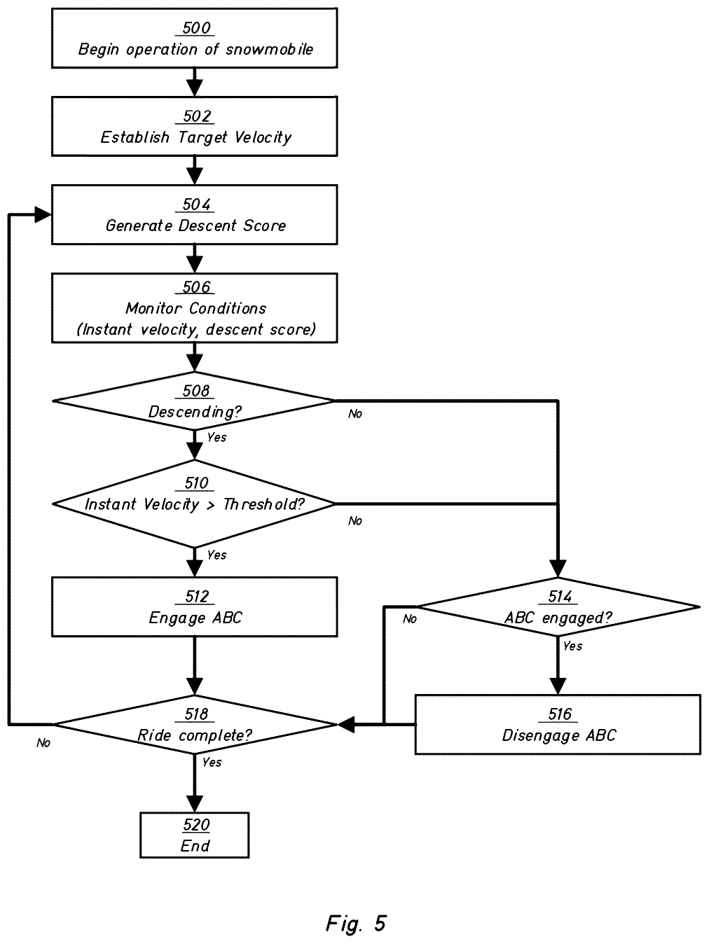

FIG. 5 is a flowchart illustrating a method of velocity governance for a snowmobile (such as snowmobile 100; see FIG. 1). The method begins at step 500 with the initial activation of the snowmobile for operation. After activation, a target velocity is established at step 502. This step establishes an initial target velocity, but the target velocity may be dynamically adjusted during operation, as described above with respect to FIG. 3 and FIG. 4, without deviating from the teachings disclosed herein.

At step 504, a descent score is generated to indicate whether the snowmobile is being maneuvered down an incline or slope. The descent score may be generated utilizing a number of sensors of the snowmobile (such as velocity sensors 123 and multi-dimensional accelerometer 125; see FIG. 1) to determine the motion of the snowmobile. In some embodiments, the descent score can be a normalized value obtained based upon the difference of the accelerometer data and an expected value. The expected value can be determined using rotational data indicating the speed of propulsion components of the snowmobile (such as tread 101 or wheels 103; see FIG. 1), and conditions of driving controls (such as throttle control 111 and brake control 113; see FIG. 1). The resulting difference can be utilized to indicate the expected behavior compared to the observed behavior. If the difference is positive, the descent score will be above zero and it can be interpreted to understand that the snowmobile is experiencing downslope motion. If the difference is negative, the descent score will be below zero and can be interpreted to understand that the snowmobile is experiencing upslope motion. Other calculations may be utilized to generate a descent score or other data indicating a motion down an incline without deviating from the teachings disclosed herein.

Once the initial descent score is calculated, other conditions are monitored that are useful for the determination of driving conditions of the snowmobile at step 506. These conditions may comprise a recalculation of the descent score in keeping with current conditions, instant velocity, condition of the throttle control, and condition of the brake control. Additionally at step 506, dynamic adjustments may be made to the target velocity in the manner described above with respect to FIG. 3 and FIG. 4. Although the depicted embodiment shows step 504 preceding step 506, these steps may be accomplished in any order, or partially or completely concurrently, without deviating from the teachings disclosed herein.

Once the data has been accumulated and scores generated, the method proceeds to step 508, wherein the method enters a subprocess to determine whether it is appropriate to engage an active brake mechanism via an active brake controller (ABC) suitable to engage the brakes of the snowmobile independent of the brake control provided to the user. Step 508 first checks if the current conditions indicate that the snowmobile is descending. If so, the method proceeds to step 510 to check if the instant velocity is greater than the current target velocity. If both conditions are satisfied, the method proceeds to step 512 where the ABC is engaged and brake force is applied. If either condition is not met, the ABC should not be engaged, and the method moves to step 514 to determine if the ABC is already engaged. If so, the ABC is disengaged at step 516, otherwise the method proceeds to step 518. Although in the depicted embodiment step 508 is shown before step 510, these steps may be accomplished in any order, or partially or completely concurrently, without deviating from the teachings disclosed herein. With further regard to step 510, although the method as depicted checks if the instant velocity of the snowmobile is greater than the threshold target velocity, this step could alternatively be implemented using a comparison of greater than or equal to without deviating from the teachings disclosed herein.

After the ABC has been placed in the appropriate operating condition, the method checks if the ride has been completed at step 518, for reasons such as deactivation of the snowmobile. If the ride is complete, the method ends at step 520, otherwise the method returns to step 504 to continue operating iteratively until the ride is completed. Note that in some embodiments, step 518 may also check if an active brake control mode is disengaged by a user during the ride. In such embodiments, the method may proceed to step 520 in response to the disengagement of the active brake control mode. When the mode is reactivated in such embodiments, the method begins again at step 500.

In some embodiments, the active brake control mode may exhibit a “stuttering” effect in instances where the snowmobile is operated at instant velocities very close to the target velocity regularly. In these instances, the “stuttering” occurs when the active brake control engages the brake forces quickly upon reaching the target velocity and releases the brake quickly after dropping below the target velocity. If the operating speed of the snowmobile exhibits small variations in speed near the target velocity, the result will be rapid engagement/disengagement of the brakes independent of user control, which some riders may dislike.

To avoid this undesired “stuttering” effect, the snowmobile can engage and disengage the ABC in response to threshold speeds that are correlated to the target velocity, but are not necessarily equivalent to the target velocity. A high threshold can be set at a speed greater than the target velocity and a low threshold can be set at a speed below the target velocity. The thresholds can be fixed values correlated to the target velocity. For example, the high threshold could be fixed at a value of +5 mph above the target velocity and the low threshold could be fixed at a value of −5 mph below the target velocity. Alternatively, the thresholds could be relative speeds correlated to the target velocity. For example, the high threshold could be set at 110% of the target velocity and the lower threshold could be set at 90% of the target velocity. Although these examples provided are symmetrical with respect to the target velocity, some embodiments may utilize asymmetric ranges (e.g., +5 mph and −3 mph from target velocity) or even mixed correlation ranges (e.g., +10% and −3 mph from target velocity) without deviating from the teachings disclosed herein. In some embodiments, a user may adjust the thresholds to their preference, advantageously providing users with different riding confidence better control of active brake behavior that makes them feel comfortable while riding.

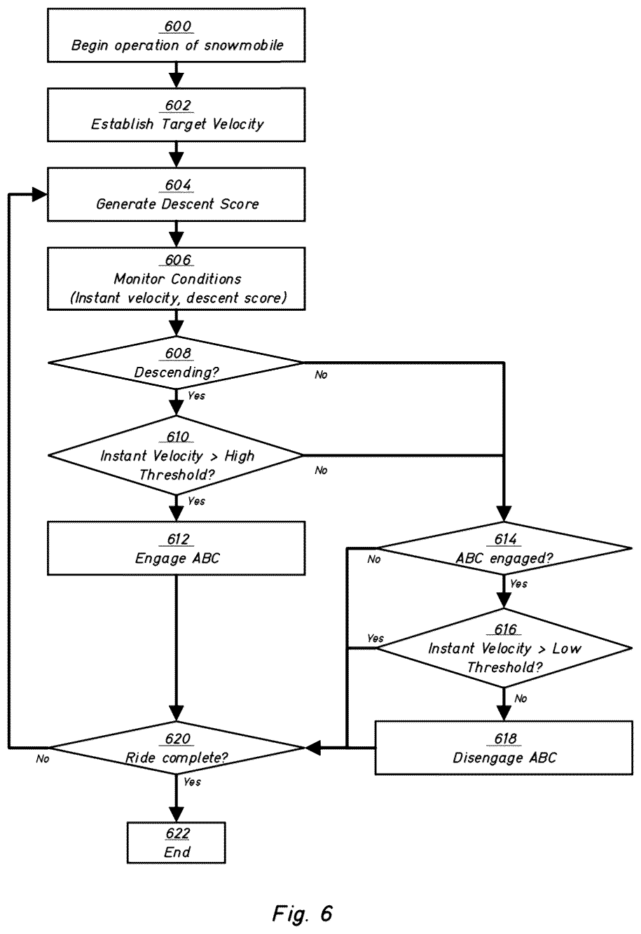

An alternative method of operating an active brake mode that minimizes the “stuttering” effect is depicted in FIG. 6. The method begins at step 600 with the initial activation of the snowmobile for operation. After activation, a target velocity is established at step 602. This step establishes an initial target velocity, but the target velocity may be dynamically adjusted during operation, as described above with respect to FIG. 3 and FIG. 4, without deviating from the teachings disclosed herein.

At step 604, a descent score is generated to indicate whether the snowmobile is being maneuvered down an incline or slope. The descent score may be generated utilizing a number of sensors of the snowmobile (such as velocity sensors 123 and multi-dimensional accelerometer 125; see FIG. 1) to determine the motion of the snowmobile. In some embodiments, the descent score can be a normalized value obtained based upon the difference of the accelerometer data and an expected value. The expected value can be determined using rotational data indicating the speed of propulsion components of the snowmobile (such as tread 101 or wheels 103; see FIG. 1), and conditions of driving controls (such as throttle control 111 and brake control 113; see FIG. 1). The resulting difference can be utilized to indicate the expected behavior compared to the observed behavior. If the difference is positive, the descent score will be above zero and it can be interpreted to understand that the snowmobile is experiencing downslope motion. If the difference is negative, the descent score will be below zero and can be interpreted to understand that the snowmobile is experiencing upslope motion. Other calculations may be utilized to generate a descent score or other data indicating a motion down an incline without deviating from the teachings disclosed herein.

Once the initial descent score is calculated, other conditions are monitored that are useful for the determination of driving conditions of the snowmobile at step 606. These conditions may comprise a recalculation of the descent score in keeping with current conditions, instant velocity, condition of the throttle control, and condition of the brake control. Additionally at step 606, dynamic adjustments may be made to the target velocity in the manner described above with respect to FIG. 3 and FIG. 4. Notably, dynamic adjustments to the target velocity will respectively result in similar dynamic adjustments made to the high threshold and the low threshold values. In embodiments that permit a user to make adjustments to the threshold values, step 606 is additionally where the system updates the threshold values during operation, although other embodiments may comprise a distinct additional step for this update without deviating from the teachings disclosed herein.

Although the depicted embodiment shows step 604 preceding step 606, these steps may be accomplished in any order, or partially or completely concurrently, without deviating from the teachings disclosed herein.

Once the data has been accumulated and scores generated, the method proceeds to step 608, wherein the method enters a subprocess to determine whether it is appropriate to engage an active brake mechanism via an active brake controller (ABC) suitable to engage the brakes of the snowmobile independent of the brake control provided to the user. Step 608 first checks if the current conditions indicate that the snowmobile is descending. If so, the method proceeds to step 610 to check if the instant velocity is greater than the high threshold. If both conditions are satisfied, the method proceeds to step 612 where the ABC is engaged and brake force is applied. If either condition is not met, the ABC should not be engaged, and the method moves to step 614 to determine if the ABC is already engaged. If the ABC is engaged, the method proceeds to step 616 to determine if disengagement will cause a potential stutter. If the instant velocity is greater than the low threshold, then the ABC should not yet be disengaged, and the method proceeds to step 620. If the instant velocity is below the low threshold, then the method instead proceeds to step 618 where the ABC is disengaged.

Although in the depicted embodiment step 608 is shown before step 610, these steps may be accomplished in any order, or partially or completely concurrently, without deviating from the teachings disclosed herein. With further regard to step 610, although the method as depicted checks if the instant velocity of the snowmobile is greater than the threshold target velocity, this step could alternatively be implemented using a comparison of greater than or equal to without deviating from the teachings disclosed herein.

After the ABC has been placed in the appropriate operating condition, the method checks if the ride has been completed at step 620, for reasons such as deactivation of the snowmobile. If the ride is complete, the method ends at step 622, otherwise the method returns to step 604 to continue operating iteratively until the ride is completed. Note that in some embodiments, step 620 may also check if an active brake control mode is disengaged by a user during the ride. In such embodiments, the method may proceed to step 522 in response to the disengagement of the active brake control mode. When the mode is reactivated in such embodiments, the method begins again at step 600.

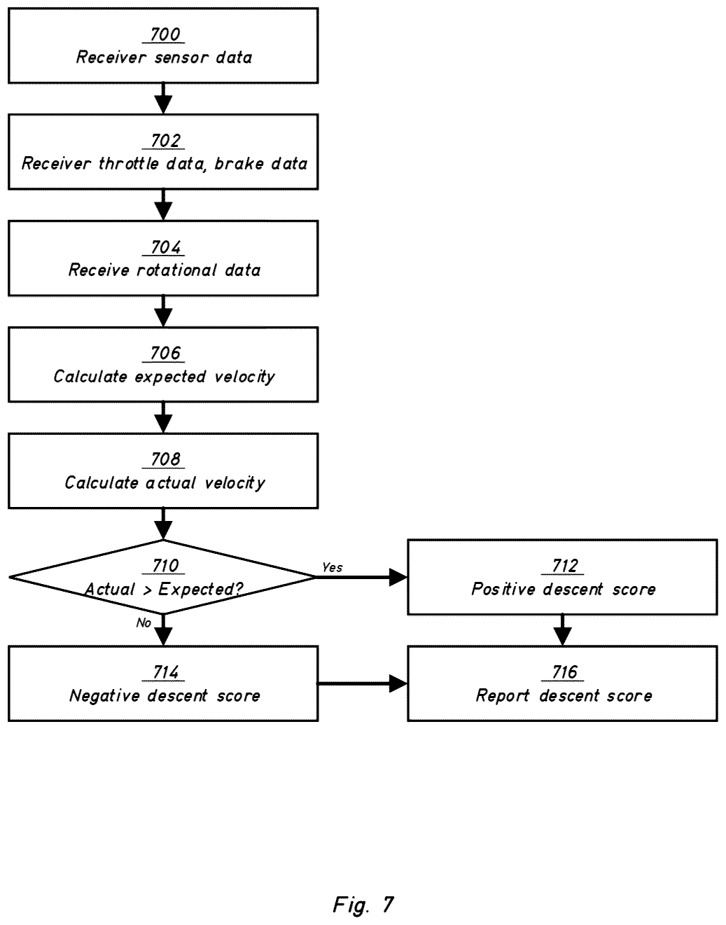

Determining the descent score at step 504 of FIG. 5 and step 604 of FIG. 6 is a critical element of the method because the descent score indicates whether or not the snowmobile is potentially experiencing acceleration beyond the control inputs provided by a user during a ride. FIG. 7 is a flowchart providing a subprocess of calculating a descent score according to one embodiment of the invention disclosed herein.

The generation of the descent score begins at step 700 wherein sensor data is received from sensors of a snowmobile (such as velocity sensors 123 and multi-dimensional accelerometer 125; see FIG. 1). The sensors provide data including velocity data and accelerometer data for the snowmobile. Once the sensor data is received, the method proceeds to step 702, where operating data indicating operating conditions of user controls, including a throttle control (such as throttle control 111; see FIG. 1) and brake control (such as brake control 113) is received.

The method then proceeds to step 704, wherein rotational data is received from sensors indicating the rotating conditions for propulsion components of the snowmobile, such as a tread (such as tread 101; see FIG. 1), and/or wheels (such as wheels 103; see FIG. 1).

In the depicted embodiment, steps 700-704 are depicted sequentially, but other embodiments may perform these steps in a different order, including orders where two or more steps are partially or completely performed concurrently without deviating from the teachings herein.

Once the data has been received, the method proceeds to step 706, where an expected velocity is calculated using the accelerometer data, velocity data, throttle data, and rotational data. The expected velocity comprises an expected velocity of the snowmobile based upon the measured movements of the rotating propulsion components compared to the measured motion of the snowmobile as a whole in a forward direction. This expected velocity is additionally calculated by considering the expected changes in acceleration caused by engagement of the throttle control or brake control, if any. Once that expected velocity is calculated, the actual instant velocity of the snowmobile is calculated at step 708. Typically, this calculation relies upon velocity data from one or more of the velocity sensors.

In the depicted embodiment, steps 706-708 are depicted sequentially, but other embodiments may perform these steps in a different order, including orders where the steps are partially or completely performed concurrently without deviating from the teachings herein.

Once the calculated values have been acquired, a difference is calculated between the actual instant velocity and the expected velocity at step 710. If the actual velocity is greater than the expected velocity, that indicates that the snowmobile is undergoing some acceleration outside of the user operational inputs, and a positive descent score is assigned at step 712. If the expected value is equal or greater than the actual velocity, that indicates that there are no acceleration component outside of user input, or that the snowmobile is operating in conditions that contribute to so deceleration components beyond user control inputs (e.g., driving up a hill or in very high friction environments). In such conditions, a negative descent score is instead assigned at step 714, as all velocity increases originate from the user input controls.

After the assignment of a positive or negative descent score, the method concludes at step 716, where the descent score is reported back to the broader method requiring its use.

In the depicted embodiment, the descent score is effectively a binary positive/negative value. However, in some embodiments, the magnitude of the discovered descent score may be utilized as an indication of the degree of descent without deviating from the teachings disclosed herein. In such embodiments, a very large positive descent score may indicate downslope motion down a very steep incline, a moderate positive value may indicate downslope motion down a shallow incline, a very small positive/negative value near zero may indicate a relatively level surface, a moderate negative value may indicate upslope motion up a shallow incline, and a very large negative value may indicate upslope motion up a very steep incline. Other embodiments may comprise other configurations without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A velocity governance method for a snowmobile, the method comprising:
establishing a target velocity for the snowmobile;
generating a descent score indicating whether the snowmobile is descending a slope;
engaging a brake mechanism in response to an instant velocity of the snowmobile increasing beyond the target velocity and the descent score indicating that the snowmobile is descending a slope, the brake mechanism suitable to slow the rotation of a propulsion component of the snowmobile; and
disengaging the brake mechanism in response to the instant velocity falling below the target velocity.

2. The velocity governance method of claim 1, wherein the target velocity is established dynamically in response to engagement of a driving control of the snowmobile.

3. The velocity governance method of claim 2, wherein the driving control of the snowmobile comprises a throttle control, and establishing the target velocity comprises increasing the target velocity until engagement of the throttle control discontinues.

4. The velocity governance method of claim 2, wherein the driving control comprises a brake control, and establishing the target velocity comprises decreasing the target velocity until engagement of the brake control discontinues.

5. The velocity governance method of claim 4, wherein the driving control further comprises a throttle control, and establishing the target velocity comprises increasing the target velocity until engagement of the throttle control discontinues.

6. The velocity governance method of claim 1, wherein generating the descent score that the snowmobile is descending a slope comprises:
receiving accelerometer data from an accelerometer, the accelerometer data comprising acceleration measurements according to a plurality of dimensions, including at least a forward dimension relative to a chassis of the snowmobile;
receiving throttle data from a throttle position sensor, the throttle data indicating the instantaneous throttle position;
receiving rotational data from a rotational sensor, the rotational data indicating the instantaneous moving speed of the propulsion component; and
assigning the descent score in view of the accelerometer data, the descent score calculated using the accelerometer data and an expected velocity, the expected velocity calculated from the rotational data, wherein the rotational data is normalized based upon an expected value in view of the throttle data,
wherein
the descent score indicates downslope motion if the difference is greater than or equal to a threshold, and
the descent score does not indicate downslope motion if the difference is less than the threshold.

7. A snowmobile comprising:
a propulsion component operated using a rotational motion;
a throttle control configured to engage the rotational motion;
a brake mechanism configured to slow the rotational motion;
a brake control configured to engage the brake mechanism;
an active brake controller configured to engage the brake mechanism independently of the brake control;
a memory in data communication with the active brake controller, the memory storing thereon a target velocity value;
a processor in data communication with the active brake controller,
wherein
the processor is configured to generate a descent score of whether the snowmobile is descending a slope, and
the active brake controller is configured to engage in response to an instant velocity of the snowmobile increasing beyond the target velocity and the descent score indicates that the snowmobile is descending a slope.

8. The snowmobile of claim 7, wherein the active brake controller is configured to disengage in response to the instant velocity of the snowmobile decreasing below a threshold value or an assessment that the snowmobile is not descending a slope.

9. The snowmobile of claim 8, wherein the threshold value is smaller than the target velocity.

10. The snowmobile of claim 7, wherein the target velocity is increased in response to a user engaging the throttle control to accelerate the snowmobile beyond the current target velocity.

11. The snowmobile of claim 7, wherein the target velocity is decreased in response to a user engaging the brake control to decelerate the snowmobile to a velocity below the current target velocity.

12. The snowmobile of claim 11, wherein the target velocity is increased in response to a user engaging the throttle control to accelerate the snowmobile beyond the current target velocity.

13. A velocity governance method for a snowmobile, the method comprising:
establishing a target velocity for the snowmobile;
generating a descent score indicating whether the snowmobile is descending a slope;
engaging a brake mechanism in response to an instant velocity of the snowmobile increasing beyond a high threshold value and the descent score indicating that the snowmobile is descending a slope, the brake mechanism suitable to slow the rotation of a propulsion component of the snowmobile; and
disengaging the brake mechanism in response to the instant velocity falling below a low threshold value,
wherein
the high threshold value is at equal to or greater than the target velocity, and
the low threshold value is equal to or lesser than the target velocity.

14. The velocity governance method of claim 13, wherein the target velocity is established dynamically in response to engagement of a driving control of the snowmobile.

15. The velocity governance method of claim 14, wherein driving control of the snowmobile comprises a throttle control and a braking control, and wherein
the target velocity is increased when the throttle control is engaged and the instant velocity of the snowmobile is equal to or greater than the target velocity, and
the target velocity is increased when the braking control is engaged and the instant velocity of the snowmobile is equal to or greater than the target velocity.
